(19) United States
(12) Patent Application Publication
(10) Pub. No.: US 2025/0368220 A1
(43) Pub. Date: Dec. 4, 2025

(54) Vehicle Control Device

(71) Applicant: HITACHI ASTEMO LTD., Hitachinaka-shi, Ibaraki (JP)

(72) Inventors: Hiroki OMATSU, Chiyoda-ku, Tokyo (JP); Takeshi FUKUDA, Chiyoda-ku, Tokyo (JP); Koji MAEDA, Hitachinaka-shi, Ibaraki (JP); Tomohito EBINA, Hitachinaka-shi, Ibaraki (JP); Takashi MURAKAMI, Hitachinaka-shi, Ibaraki (JP)

(21) Appl. No.: 18/873,805

(22) PCT Filed: May 22, 2023
(86) PCT No.: PCT/JP2023/018868

§ 371 Date: Dec. 11, 2024

(30) Foreign Application Priority Data
Jul. 8, 2022 (JP) 2022-110452

(51) Int. Cl. B60W 60/00; B60W 30/06; B60W 30/18; B60W 50/14; G06F 11/3604

(52) U.S. Cl. CPC B60W 60/001; B60W 30/06; B60W 30/18018; B60W 50/14; G06F 11/3604; B60W 2050/146; B60W 2420/403; B60W 2552/00; B60W 2554/4023; B60W 2554/4042; B60W 2554/406; B60W 2555/60; B60W 2556/20; B60W 2556/45

(57) ABSTRACT

A vehicle control device includes an execution available duration prediction unit configured to predict an execution available duration of a current automatic driving control software program based on external environmental information of a vehicle; and a verification target choosing unit configured to choose, from verification scenarios for verifying performance of a new automatic driving control software program, a verification scenario that can be executed and completed within the execution available duration as a verification target.

### TECHNICAL FIELD

The present invention relates to a vehicle control device.

### BACKGROUND ART

Conventionally, as a safety evaluation method of an automatic driving control software program (hereinafter abbreviated as “automatic driving control software”) of a vehicle, there is an evaluation method called Shadow Mode in which automatic driving control software is executed in a background by using external environmental information in an actual vehicle and evaluated.

However, in order to realize the Shadow Mode, it is necessary to mount high-performance hardware on the vehicle, and there is a problem that vehicle manufacturing cost increases. Therefore, a technique capable of verifying automatic driving control software without adding high-performance hardware to a vehicle (see PTL 1) has been proposed.

PTL 1 describes that the vehicle control device “executes old control software unit indicating an old version of control software and new control software unit indicating a new version of control software in parallel or parallel” and “verifies by using available resource (time, CPU) in which the old control software is not executed”.

### CITATION LIST

### Patent Literature

PTL 1: JP 2022-013187 A

### SUMMARY OF INVENTION

### Technical Problem

As described above, conventionally, there has been proposed a technique for verifying the safety of new automatic driving control software by executing the new automatic driving control software in an execution available time of the old automatic driving control software. However, depending on the size of the driving scenario, verification of the new automatic driving control software may not be completed in an execution available time of the old automatic driving control software. That is, in the conventional technique, there occurs a problem that a driving scenario having an optimum size cannot be selected as a verification target according to an execution available time of the old automatic driving control software. In a case where such a problem occurs, verification is redone, and verification efficiency is reduced.

The present invention has been made to solve the above problems, and an object of the present invention is to provide a vehicle control device capable of dynamically selecting a verification scenario that can be executed and completed within an execution available duration and improving a verification efficiency of an automatic driving control software program.

### Solution to Problem

A vehicle control device of the present invention includes an execution available duration prediction unit configured to predict an execution available duration of a current automatic driving control software program based on external environmental information of a vehicle; and a verification target choosing unit configured to choose, from verification scenarios for verifying performance of a new automatic driving control software program, a verification scenario that can be executed and completed within the execution available duration as a verification target.

### Advantageous Effects of Invention

According to the present invention having the above configuration, a vehicle control device capable of dynamically selecting a verification scenario that can be executed and completed within an execution available duration and improving a verification efficiency of the automatic driving control software program can be provided.

Problems, configurations, and effects other than the above will be clarified by the following description of each embodiment.

### BRIEF DESCRIPTION OF DRAWINGS

FIG. 1 is a diagram for describing a connection relationship with various devices in a vehicle of a vehicle control device according to a first embodiment of the present invention.

FIG. 2 is a block diagram illustrating a configuration example of the vehicle control device according to the first embodiment of the present invention.

FIG. 3 is a flowchart illustrating a procedure of an acquisition process of external environmental information in the information acquisition unit of the vehicle control device according to a first embodiment of the present invention.

FIG. 4 is a diagram illustrating an example of data of the external environmental information acquired in the vehicle control device according to the first embodiment of the present invention.

FIG. 5 is a diagram illustrating an example of new SW information in the vehicle control device according to the first embodiment of the present invention.

FIG. 6 is a flowchart illustrating a procedure of a verification scenario saving process in a verification scenario saving unit of the vehicle control device according to the first embodiment of the present invention.

FIG. 7 is a diagram illustrating an example of data of a verification scenario saved in the vehicle control device according to the first embodiment of the present invention.

FIG. 8 is a flowchart illustrating a procedure of a prediction process of an execution available duration in an execution available duration prediction unit of the vehicle control device according to the first embodiment of the present invention.

FIG. 9 is a diagram illustrating an example of data of the execution available duration in the vehicle control device according to the first embodiment of the present invention.

FIG. 10 is a flowchart illustrating a procedure of process in a computation unit of the vehicle control device according to the first embodiment of the present invention.

FIG. 11 is a flowchart illustrating a procedure of verification scenario selecting process in a verification target choosing unit of the vehicle control device according to the first embodiment of the present invention.

FIG. 12 is a diagram illustrating an example of data of automatic driving end information in the vehicle control device according to the first embodiment of the present invention.

FIG. 13 is a diagram illustrating an example of data of a verification scenario chosen in the vehicle control device according to the first embodiment of the present invention.

FIG. 14 is a diagram illustrating an example of data of an execution result of a computation unit of the vehicle control device according to the first embodiment of the present invention.

FIG. 15 is a flowchart illustrating a procedure of a verification process of a new automatic driving control software in the verification unit of the vehicle control device according to the first embodiment of the present invention.

FIG. 16 is a block diagram illustrating a functional configuration of a vehicle control device according to a second embodiment of the present invention.

FIG. 17 is a flowchart illustrating a procedure of a prediction process of an execution available duration in an execution available duration prediction unit of the vehicle control device according to the second embodiment of the present invention.

FIG. 18 is a diagram illustrating an example of data of object information in the vehicle control device according to the second embodiment of the present invention.

FIG. 19 is a diagram for explaining a connection relationship in a vehicle by a vehicle control device according to a third embodiment of the present invention.

FIG. 20 is a diagram illustrating an example of information acquired from an in-vehicle user interface in a vehicle control device according to the third embodiment of the present invention.

FIG. 21 is a flowchart illustrating a procedure of a prediction process of an execution available duration in an execution available duration prediction unit of the vehicle control device according to the third embodiment of the present invention.

FIG. 22 is a flowchart illustrating a procedure of dividing process of a verification target scenario in a verification target choosing unit of a vehicle control device according to a fourth embodiment of the present invention.

FIG. 23 is a diagram illustrating an example of data of a verification scenario to which priority is assigned in a vehicle control device according to a fifth embodiment of the present invention.

FIG. 24 is a flowchart illustrating a procedure of verification scenario selecting process in a verification target choosing unit of the vehicle control device according to the fifth embodiment of the present invention.

FIG. 25 is a diagram illustrating an example of outside world information acquired by a vehicle control device according to a sixth embodiment of the present invention.

FIG. 26 is a diagram illustrating an example of information on an internal state of a controller unit acquired in the vehicle control device according to a seventh embodiment of the present invention.

FIG. 27 is a block diagram illustrating a hardware configuration of a vehicle control device according to each embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description is omitted.

### First Embodiment

Before describing the configuration of the vehicle control device according to the present embodiment, first, a connection relationship between various devices in a vehicle on which the vehicle control device according to the present embodiment is mounted and the vehicle control device will be described.

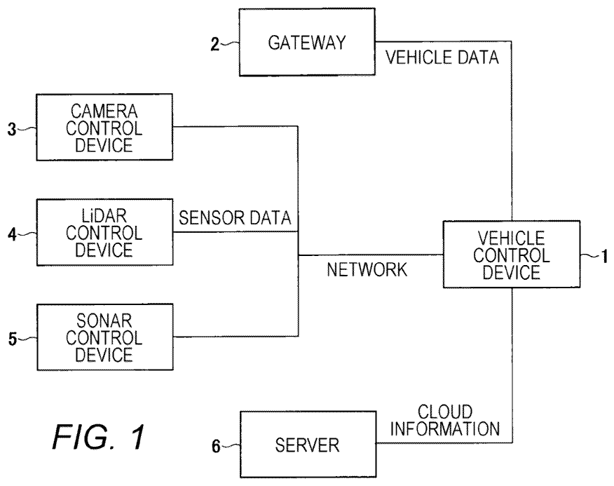

FIG. 1 is a diagram for describing a connection relationship with various devices in the vehicle of a vehicle control device 1 according to the present embodiment.

As illustrated in FIG. 1, the vehicle control device 1 is connected to a gateway 2, and acquires vehicle data such as a vehicle speed, information of new automatic driving control software (hereinafter referred to as new SW information), and the like from the gateway 2. In addition, the vehicle control device 1 acquires various pieces of sensor information from various sensor control devices such as a camera control device 3, a light detection and ranging (LIDAR) control device 4, and a sonar control device 5 via an in-vehicle network. Furthermore, the vehicle control device 1 acquires cloud information such as red duration information of a traffic light in an intersection ahead of the vehicle, map data, and the like from a server 6 via cloud communication.

### Configuration Example of Vehicle Control Device

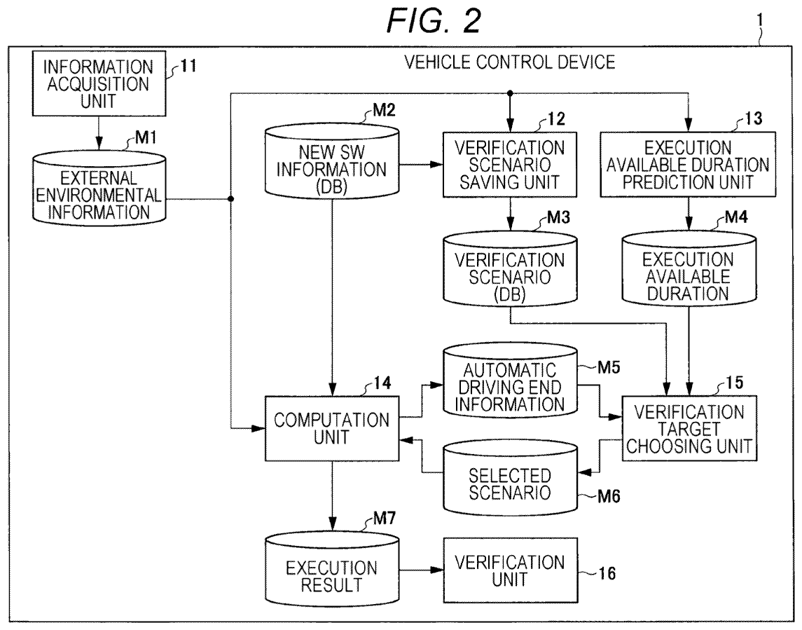

Next, a configuration of the vehicle control device 1 according to the present embodiment will be described. FIG. 2 is a block diagram illustrating a configuration example of the vehicle control device 1 according to the present embodiment. As illustrated in FIG. 2, the vehicle control device 1 includes an information acquisition unit 11, a verification scenario saving unit 12, an execution available duration prediction unit 13, a computation unit 14, a verification target choosing unit 15, and a verification unit 16. The information acquisition unit 11 is connected to each of the verification scenario saving unit 12, the execution available duration prediction unit 13, and the computation unit 14. Each of the verification scenario saving unit 12, the execution available duration prediction unit 13, and the computation unit 14 is also connected to the verification target choosing unit 15. Furthermore, the computation unit 14 is also connected to the verification unit 16.

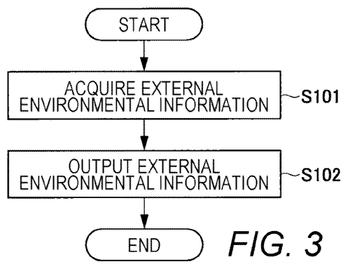

The information acquisition unit 11 acquires various types of sensor information as the external environmental information M1 from various types of sensor control devices via the in-vehicle network, and outputs the external environmental information M1 to the verification scenario saving unit 12, the execution available duration prediction unit 13, and the computation unit 14. In addition, the information acquisition unit 11 acquires cloud information from the server 6 as the external environmental information M1 via cloud communication. Note that the process of acquiring the external environmental information in the information acquisition unit 11 will be described later in detail with reference to FIG. 3.

The verification scenario saving unit 12 performs a verification scenario saving process based on the new SW information M2 input from the gateway 2 and the external environmental information M1 input from the information acquisition unit 11.

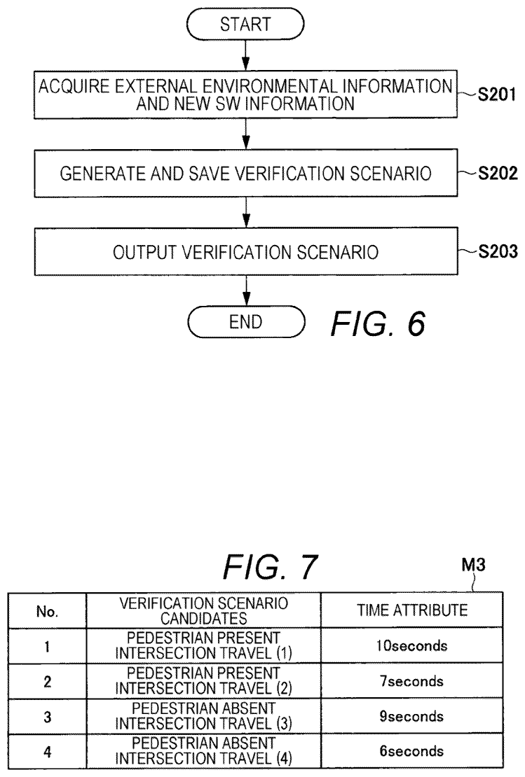

In addition, the verification scenario saving unit 12 outputs the saved verification scenario M3 to the verification target choosing unit 15. Note that the verification scenario saving process in the verification scenario saving unit 12 will be described later in detail with reference to FIG. 6.

The execution available duration prediction unit (execution available duration prediction unit 13) predicts an execution available duration M4 of the current automatic driving control software based on the external environmental information of the vehicle. For example, the execution available duration prediction unit 13 predicts the execution available duration M4 based on the external environmental information M1 input from the information acquisition unit 11. The execution available duration M4 is, for example, a time during which a driver of the vehicle is driving and automatic driving is not performed, or a time during which the automatic driving mode is shifted to the automatic parking mode and the vehicle control device 1 is not performing an automatic driving process, and a time during which the computation unit 14 is not executing the current SW is assumed. Note that a time continued at the execution rate of the computation unit 14 (the used computation amount with respect to the total computation amount of the computation unit 14) of less than a predetermined value (e.g., 30%) may be set as the execution available duration M4.

In a case where the traffic light ahead of the vehicle changes from yellow lighting to red lighting during automatic driving of the vehicle, the execution available duration prediction unit 13 can predict that the vehicle will stop before the traffic light in a few seconds, and thus a period until the traffic light turns green can be predicted as the execution available measurement time M4. In addition, when the vehicle enters the parking lot and starts to decelerate, the vehicle will automatically park in a few seconds, and thus the automatic driving is stopped, whereby the execution available duration prediction unit 13 can also predict a period during which the automatic driving is stopped as the execution available measurement time M4.

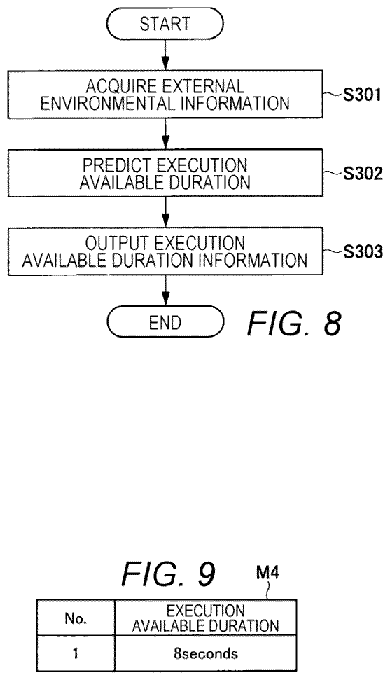

Note that the external environmental information of the vehicle includes, for example, external environmental information M1 acquired from a sensor that detects the external environment of the vehicle, image information of an arbitrary object indicating that the automatic driving ends described later, and the like. Since the information acquisition unit 11 can acquire the external environmental information of the vehicle by various means, the execution available duration prediction unit 13 can accurately predict the execution available measurement time M4. In addition, the execution available duration prediction unit 13 outputs the predicted execution available duration M4 to the verification target choosing unit 15. Note that the prediction process of the execution available duration M4 in the execution available duration prediction unit 13 will be described in detail with reference to FIG. 8 to be described later.

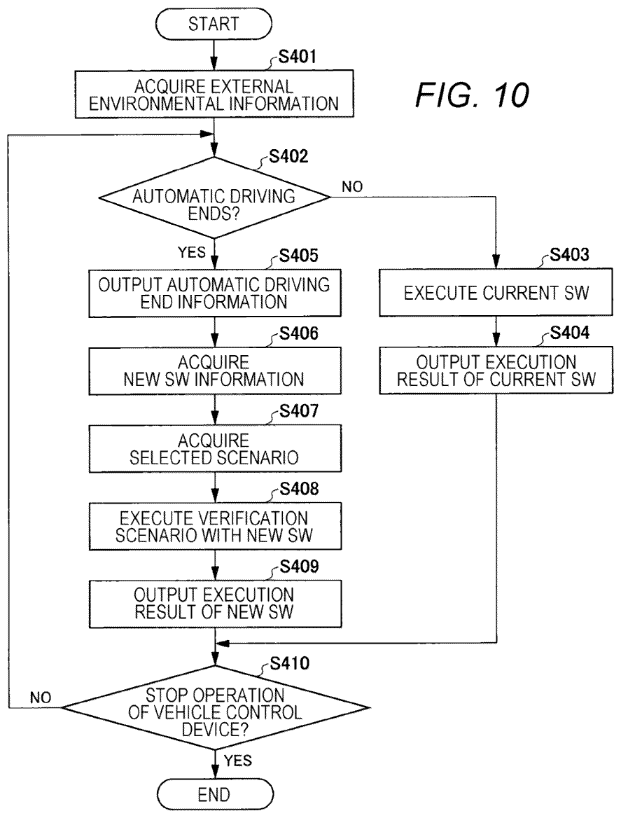

The computation unit 14 determines whether or not the automatic driving ends based on the external environmental information M1 input from the information acquisition unit 11. When determining that the automatic driving continues, the computation unit 14 continuously executes the current automatic driving control software (current SW) and outputs an execution result M7 of the automatic driving to the verification unit 16. Furthermore, when determining that the automatic driving ends, the computation unit 14 outputs an automatic driving end information M5 indicating that the automatic driving ends to the verification target choosing unit 15. In addition, the computation unit (computation unit 14) executes a selected scenario M6 (verification target) with the new automatic driving control software program in the execution available duration M4, and outputs an execution result M7 of the new SW to the verification unit 16. Note that the above-described processes in the computation unit 14 will be described in detail with reference to FIG. 10 to be described later.

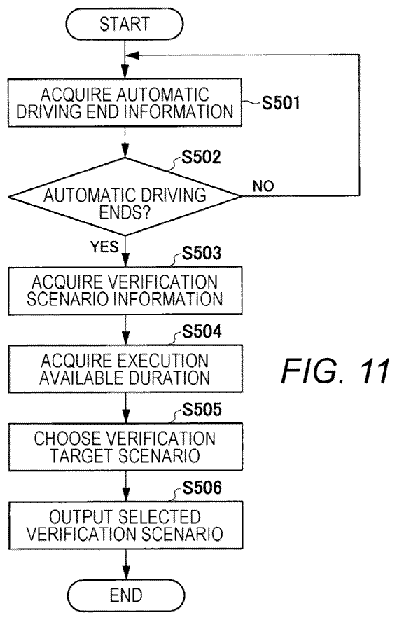

The verification target choosing unit (verification target choosing unit 15) chooses, as a verification target, a verification scenario that can be executed and completed within the execution available duration M4 from the verification scenario M3 for verifying the performance of the new automatic driving control software saved by the verification scenario saving unit 12. In addition, the verification target choosing unit 15 outputs the selected verification scenario (hereinafter referred to as a selected scenario M6) to the computation unit 14. Note that the verification scenario selecting process in the verification target choosing unit 15 will be described in detail with reference to FIG. 11 to be described later.

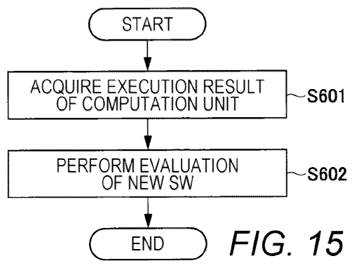

The verification unit (verification unit 16) verifies the new automatic driving control software program based on the computation result of the current automatic driving control software program in which the computation is executed by the computation unit (computation unit 14) in a time other than the execution available duration M4, and the computation result of the new automatic driving control software program in which the computation is executed by the computation unit (computation unit 14) within the execution available duration M4. The verification result of the new SW by the verification unit 16 is transmitted to a development company of the new SW via the Internet, and the developer of the new SW can confirm the verification result of the new SW. Note that the above-described processes in the verification unit 16 will be described in detail with reference to FIG. 15 to be described later.

Note that the new SW information M2 and the verification scenario M3 described above are saved in a database (DB) (not illustrated) configured in the nonvolatile storage device. The external environmental information M1, the execution available duration M4, the automatic driving end information M5, the selected scenario M6, and the execution result M7 may be saved in a database (DB) (not illustrated) or may be temporarily saved in a storage device (not illustrated) such as a random-access memory (RAM) or a read only memory (ROM).

### Acquisition Process of External Environmental Information in Information Acquisition Unit

FIG. 3 is a flowchart illustrating a procedure of an acquisition process of the external environmental information M1 in the information acquisition unit 11 of the vehicle control device 1 according to the present embodiment. The process described below is executed at a predetermined cycle in order to prepare the external environmental information M1 before various types of processes related to verification of the new SW are performed.

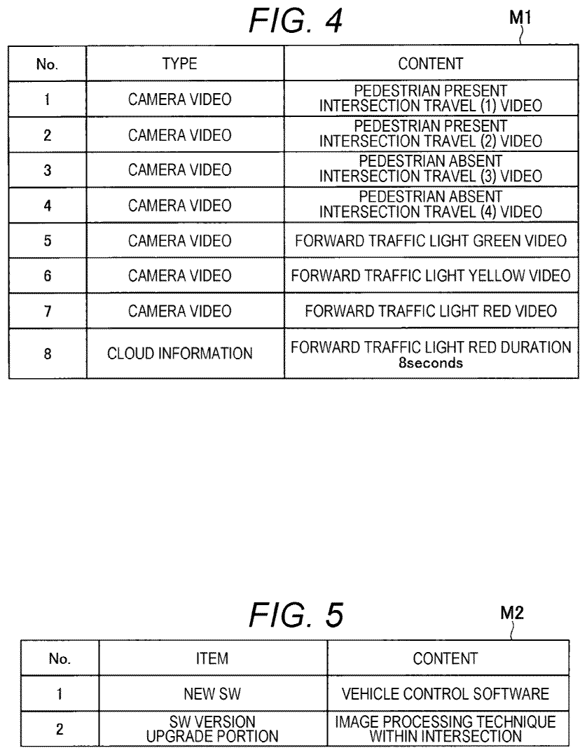

First, the information acquisition unit 11 acquires various types of external environmental information M1 (see FIG. 4) from control devices of various types of sensors connected to the vehicle control device 1, for example, the camera control device 3, the LiDAR control device 4, and the sonar control device 5 illustrated in FIG. 1 (step S101). Furthermore, in this process, the information acquisition unit 11 acquires the cloud information as the external environmental information M1 (see FIG. 4) from the server 6 via the cloud communication.

Next, the information acquisition unit 11 outputs the acquired external environmental information M1 to the verification scenario saving unit 12, the execution available duration prediction unit 13, and the computation unit 14 (step S102). After the process of step S102, the acquisition process of the sensor information is ended.

FIG. 4 is a diagram illustrating an example of data of the external environmental information M1 acquired by the information acquisition unit 11. As illustrated in FIG. 4, the external environmental information M1 includes information data of “type” and information data of “content”. “No.” is a number indicating the arrangement order of the external environmental information M1, for example, a numerical number of “1” to “8”. Note that the arrangement order of the external environmental information M1 is arbitrary.

The information data of “type” is information data corresponding to the type of the sensor that is the acquisition source of the external environmental information M1. For example, the “type” of the external environmental information M1 from the camera sensor is referred to as “camera image”, and the “type” of the external environmental information M1 from the cloud is referred to as “cloud information”.

The information data of “content” is information data indicating the content of the external environmental information M1. For example, “pedestrian present intersection travel (1) video” representing a video obtained by imaging a situation of an intersection, “forward traffic light green video” representing a video obtained by imaging a color of a traffic light ahead of the vehicle, “forward traffic light red duration 8 seconds” representing the content of cloud information, and the like can be cited.

FIG. 5 is a diagram illustrating an example of the new SW information M2 acquired by the vehicle control device 1 via the gateway 2. As illustrated in FIG. 5, the new SW information M2 includes information data of “item” and information data of “content”. “No.” is a number indicating the arrangement order of the new SW information M2, for example, a numerical number of “1” to “2”. Note that the arrangement order of the new SW information M2 is arbitrary.

The information data of the “item” is information data (e.g., “new SW”) representing that the new SW information M2 is the main body information of the new SW or information data (e.g., version upgrade portion of SW″) representing that the new SW information M2 is the information of the version upgrade portion with respect to the current SW.

The information data of “content” is information data representing the content of the new SW information M2 corresponding to “item”. For example, “vehicle control software” representing the contents of “new SW”, “image processing technique within intersection” representing the content of “version upgrade portion of SW”, and the like can be cited. The vehicle control software is software necessary for executing and controlling the new SW. In addition, as a result of the version upgrade of the image processing technique within the intersection of the new SW, if more pedestrians in the intersection can be detected than before, the verification scenario may be saved only before the vehicle enters the intersection and when the vehicle travels through the intersection. In this way, it is possible to configure such that the verification scenario is saved limiting only to a version upgraded portion from the current SW.

### Verification Scenario Saving Process in Verification Scenario Saving Unit

FIG. 6 is a flowchart illustrating a procedure of verification scenario saving process in the verification scenario saving unit 12 of the vehicle control device 1 according to the present embodiment. The processes described below are started when the verification scenario saving unit 12 acquires the external environmental information M1 from the information acquisition unit 11.

First, the verification scenario saving unit 12 acquires the external environmental information M1 from the information acquisition unit 11 and the new SW information M2 from the gateway 2 (step S201).

Next, the verification scenario saving unit 12 generates the verification scenario M3 based on the “content” corresponding to the “SW version upgrade portion” of the new SW information M2 and the external environmental information M1, and saves the verification scenario M3 in the DB (step S202). In this process, for example, the verification scenario saving unit 12 extracts the external environmental information M1 of “pedestrian present intersection travel (1) video” to “pedestrian present intersection travel (4) video” illustrated in FIG. 4 according to the new SW information M2 in which “SW version upgrade portion” illustrated in FIG. 5 is “image processing technique within intersection”, and generates and saves the verification scenario M3 (see FIG. 7 to be described later) based on the time length of each video.

Next, the verification scenario saving unit 12 outputs the verification scenario M3 to the verification target choosing unit 15 (step S203). After the process of step S203, the verification scenario saving process is ended.

FIG. 7 is a diagram illustrating an example of data of the verification scenario M3 saved by the verification scenario saving unit 12. As illustrated in FIG. 7, the verification scenario M3 includes information data of “verification scenario candidate” and information data of “time attribute”. “No.” is a number indicating the arrangement order of the verification scenario M3, for example, a numerical number of “1” to “2”.

The information data of the “verification scenario candidate” is information data representing the content of the verification scenario generated by the verification scenario saving unit 12. The information data of the “time attribute” is information data representing the length of time of the verification scenario (video) stored in the “verification scenario candidate”. For example, since the time length of the “pedestrian present intersection travel (1) video” is 10 seconds, the verification scenario M3 in which the “verification scenario candidate” is “pedestrian present intersection travel (1)” and the “time attribute” is “10 seconds” is saved.

### Prediction Process of Execution Available Duration in Execution Available Duration Prediction Unit

FIG. 8 is a flowchart illustrating a procedure of a prediction process of the execution available duration in the execution available duration prediction unit 13 of the vehicle control device 1 according to the present embodiment. The process described below is started when the execution available duration prediction unit 13 acquires the external environmental information M1 from the information acquisition unit 11.

First, the execution available duration prediction unit 13 acquires the external environmental information M1 from the information acquisition unit 11 (step S301).

Next, the execution available duration prediction unit 13 predicts the execution available duration M4 of the current SW based on the external environmental information M1 (step S302). In this process, the execution available duration prediction unit 13 predicts that the execution available duration M4 of the current SW (see FIG. 9 described later) will be “8 seconds” based on, for example, “the forward traffic light red duration 8 seconds” which is “cloud information” in the external environmental information M1 illustrated in FIG. 4.

Next, the execution available duration prediction unit 13 outputs the predicted execution available duration M4 to the verification target choosing unit 15 (step S303). After the process of step S303, the prediction process of the execution available duration is ended.

FIG. 9 is a diagram illustrating an example of data of the execution available duration in the vehicle control device 1 according to the present embodiment. The execution available duration M4 includes information (e.g., “8 seconds”) of the “execution available duration” indicating the predicted execution available duration. “No.” is a number indicating the arrangement order of the execution available duration M4, for example, a numerical number of “1”.

### Process in Computation Unit

FIG. 10 is a flowchart illustrating a procedure of a process in the computation unit 14 of the vehicle control device 1 according to the present embodiment. The process described below is started when the computation unit 14 acquires the external environmental information M1 from the information acquisition unit 11.

First, the computation unit 14 acquires the external environmental information M1 from the information acquisition unit 11 (step S401).

Next, the computation unit 14 determines whether or not the automatic driving ends based on the external environmental information M1 (step S402). In this process, for example, when the computation unit 14 determines that the automatic driving continues based on, for example, the external environmental information M1 with “the forward traffic light green video” illustrated in FIG. 4, NO determination is made in step S402. In this process, for example, when the computation unit 14 determines that the automatic driving ends based on, for example, the external environmental information M1 with “the forward traffic light red video” illustrated in FIG. 4, YES determination is made in step S402.

In the process of step S402, when determining that the automatic driving continues (in the case of NO determination in step S402), the computation unit 14 continuously executes the current SW (step S403).

Next, the computation unit 14 outputs the execution result M7 of the current SW to the verification unit 16 (step S404).

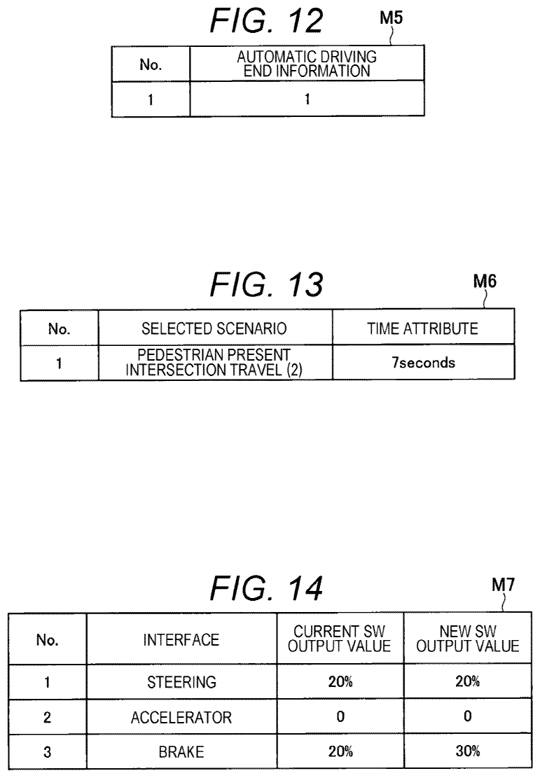

On the other hand, in the process of step S402, when determining that the automatic driving ends (in the case of YES determination in step S402), the computation unit 14 outputs automatic driving end information M5 (see FIG. 12 described later) to the verification target choosing unit 15 (step S405).

Next, the computation unit 14 acquires the new SW information M2 (see FIG. 5) saved in the DB (step S406).

Next, the computation unit 14 acquires the selected scenario M6 (see FIG. 13 to be described later) from the verification target choosing unit 15 (step S407).

Next, the computation unit 14 executes the selected scenario M6 with the automatic driving control software (new SW) included in the new SW information M2 (step S408).

Next, the computation unit 14 outputs the execution result M7 of the selected scenario M6 in the new SW to the verification unit 16 (step S409).

After the process of step S404 or step S409, the computation unit 14 determines whether or not the operation of the vehicle control device 1 is stopped (step S410).

In the process of step S410, when determining that the operation of the vehicle control device 1 is not stopped (in the case of NO determination in step S410), the computation unit 14 returns to the process of step S402 and repeatedly executes the processes of steps S402 to S410.

On the other hand, in the process of step S410, when the computation unit 14 determines that the operation of the vehicle control device 1 is stopped (in the case of NO determination in step S410), the process in the computation unit 14 is ended.

### Verification Scenario Selecting Process in Verification Target Choosing Unit

FIG. 11 is a flowchart illustrating a procedure of a verification scenario selecting process in the verification target choosing unit 15 of the vehicle control device 1 according to the present embodiment. The process described below is started when the verification target choosing unit 15 acquires the automatic driving end information M5 from the computation unit 14.

First, the verification target choosing unit 15 acquires the automatic driving end information M5 from the computation unit 14 (step S501).

Next, the verification target choosing unit 15 determines whether or not the automatic driving ends (step S502). In this process, when the acquired automatic driving end information M5 is information data indicating the end of automatic driving, for example, is “1” illustrated in FIG. 12 to be described later, the verification target choosing unit 15 determines that the automatic driving ends (in the case of YES determination in step S502). In addition, when the acquired automatic driving end information M5 is not the information data indicating the end of automatic driving, for example, is other than “1” illustrated in FIG. 12 to be described later, the verification target choosing unit 15 determines that the automatic driving continues (in the case of NO determination in step S502).

In the process of step S502, when determining that the automatic driving continues (in the case of NO determination in step S502), the verification target choosing unit 15 returns to the process of step S501 and repeatedly executes the processes of steps S501 to S502.

On the other hand, in the process of step S502, when determining that the automatic driving ends (in the case of YES determination in step S502), the verification target choosing unit 15 acquires the verification scenario M3 from the DB (step S503). In this process, the verification target choosing unit 15 acquires, for example, a verification scenario M3 to be verified designated in advance.

Next, the verification target choosing unit 15 acquires the execution available duration M4 predicted by the execution available duration prediction unit 13 (step S504).

Next, the verification target choosing unit 15 chooses a verification scenario that can be executed and completed from the acquired verification scenario M3 as the selected scenario M6 based on the execution available duration M4 (step S505). For example, the verification target choosing unit 15 chooses, as the selected scenario M6 (see FIG. 13 described later), a verification scenario of “No. 2” that can be executed and completed within “8 seconds” from the verification scenario M3 illustrated in FIG. 7 based on the execution available duration M4 of “8 seconds” illustrated in FIG. 9.

Next, the verification target choosing unit 15 outputs the chosen selected scenario M6 to the computation unit 14 (step S506). After the process of step S506, the verification scenario selecting process is ended.

FIG. 12 is a diagram illustrating an example of data of the automatic driving end information M5 in the vehicle control device 1 according to the present embodiment. As illustrated in FIG. 12, the value “1” of the “automatic driving end information” represents that the automatic driving ends. Note that the present invention is not limited thereto, and a value of the “automatic driving end information” may be arbitrarily set as long as the information data indicates that the automatic driving ends.

FIG. 13 is a diagram illustrating an example of data of a verification scenario (selected scenario M6) selected in the vehicle control device 1 according to the present embodiment. In FIG. 13, the verification scenario of the “No. 2” of FIG. 7 chosen by the verification target choosing unit 15 described in step S505 of FIG. 11 illustrated as the selected scenario M6. As illustrated in FIG. 13, the time attribute (“7 seconds”) of the selected scenario M6 is shorter than the execution available duration M4 (“8 seconds”), that is, the selected scenario M6 can be executed and completed within the execution available duration M4 (“8 seconds”).

FIG. 14 is a diagram illustrating an example of data of the execution result M7 of the computation unit 14 of the vehicle control device 1 according to the present embodiment. As illustrated in FIG. 14, the execution result M7 includes information of the interface to which the execution result is output (field of “interface”), an output result of the current SW corresponding to the interface (field of “current SW output value”), and an output result of the new SW corresponding to the interface (field of “new SW output value”). The “current SW output value” and the “new SW output value” corresponding to the field of the “interface” represent the output value of the interface as a ratio with respect to the maximum output value of the interface in percentage (%). For example, since both the “current SW output value” and the “new SW output value” of the “steering” are “20%”, it can be seen that there is no change in the steering performance. Note that the verification unit 16 compares the “current SW output value” and the “new SW output value” of the execution result M7 to evaluate the performance of the new SW. The field of the interface in FIG. 14 also includes items of an accelerator and a brake. Note that an item of gear (first speed, second speed, etc.) may be included in the field of the interface in FIG. 14.

### Evaluation Process of New Automatic Driving Control Software in Verification Unit

FIG. 15 is a flowchart illustrating a procedure of an evaluation process of the new automatic driving control software in the verification unit 16 of the vehicle control device 1 according to the present embodiment. The process described below may be executed when the execution result M7 is output from the computation unit 14, or may be executed at a predetermined cycle.

First, the verification unit 16 acquires the execution result M7 of the computation unit 14 (step S601).

Next, the verification unit 16 evaluates the performance of the new SW based on the acquired execution result M7 (step S602). In this process, for example, the verification unit 16 compares the “current SW output value” and the “new SW output value” of the execution result M7 illustrated in FIG. 14 to evaluate the performance of the new SW. After the process of step S602, the evaluation process of the new automatic driving control software is ended.

### Effects

As described above, the vehicle control device 1 according to the first embodiment of the present invention predicts the execution available duration (stop time of automatic driving) of the current automatic driving control software, and chooses the verification scenario that can be executed and completed within the execution available duration based on the predicted execution available duration. That is, the vehicle control device 1 dynamically selects the verification scenario according to the execution available duration, and executes the selected verification scenario with the new automatic driving control software to perform verification. Since the vehicle control device 1 according to the present embodiment dynamically selects the verification scenario, the verification efficiency of the automatic driving control software can be improved.

### Second Embodiment

Next, a configuration example and an operation example of a vehicle control device according to a second embodiment of the present invention will be described.

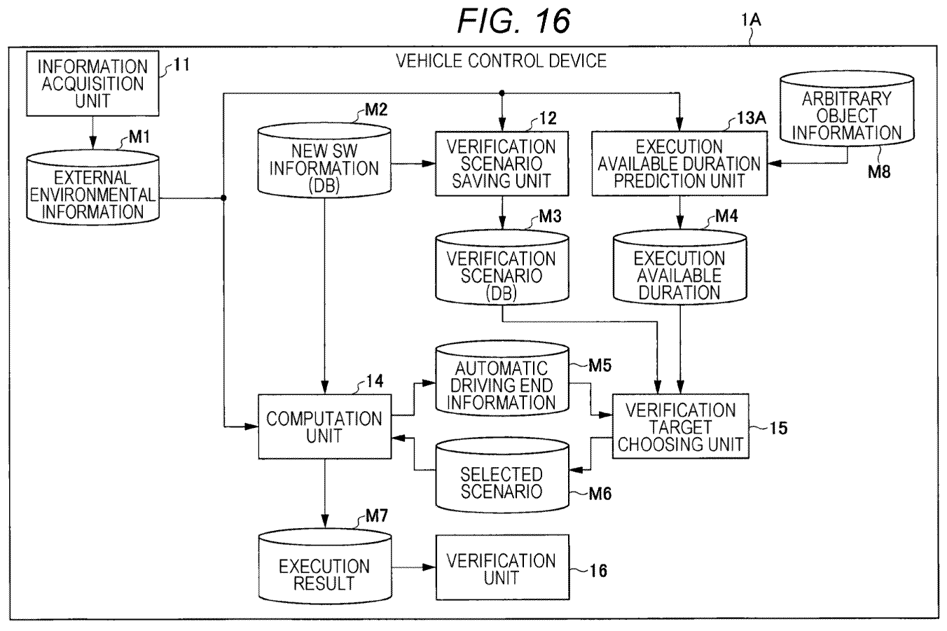

FIG. 16 is a block diagram illustrating a configuration example of a vehicle control device 1A according to the second embodiment of the present invention. As can be seen from a comparison between FIG. 16 and FIG. 2, the components of the vehicle control device 1A other than the execution available duration prediction unit 13A are similar to those illustrated in FIG. 2. Therefore, description of the same components as those of the first embodiment will be omitted.

The execution available duration prediction unit 13A predicts the execution available duration M4 based on an arbitrary object information M8 illustrated in FIG. 16 instead of predicting the execution available duration M4 based on the “cloud information” (see FIG. 4) in the external environmental information M1. That is, in the vehicle control device 1A, the object information M8 is acquired as an example of the external environmental information.

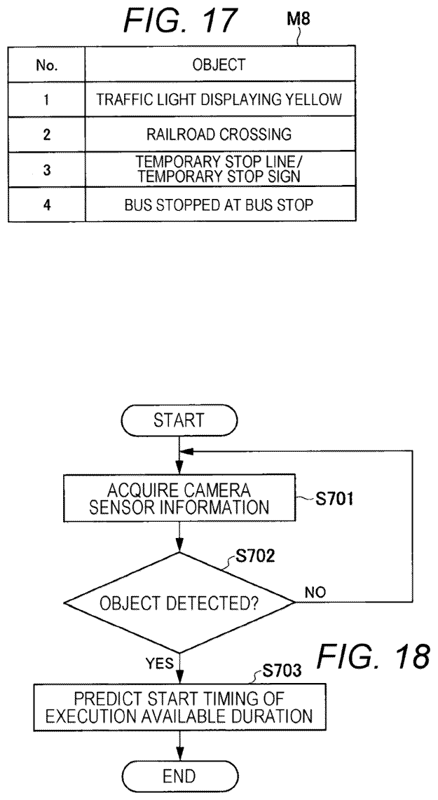

FIG. 17 is a diagram illustrating an example of data of the object information M8 in the vehicle control device 1A according to the present embodiment. The object information M8 is image information (camera sensor information) of an arbitrary object indicating that the automatic driving ends. For example, as illustrated in FIG. 17, the object information M8 includes image information of “traffic light displaying yellow”, image information of “railroad crossing”, image information of “temporary stop line/temporary stop sign”, image information of “bus stopped at bus stop”, and the like.

FIG. 18 is a flowchart illustrating a procedure of a prediction process of the execution available duration in the execution available duration prediction unit 13A of the vehicle control device 1A according to the present embodiment. The process described below is started when the execution available duration prediction unit 13A acquires the camera sensor information from the information acquisition unit 11.

First, the execution available duration prediction unit 13A acquires camera sensor information from the information acquisition unit 11 (step S701).

Next, the execution available duration prediction unit 13A determines whether or not an object has been detected from the acquired camera sensor information based on the object information M8 (step S702). In this process, the execution available duration prediction unit 13A detects an object from the camera sensor information based on the image information of the object included in the object information M8. In a case where the execution available duration prediction unit 13A has detected an object from the camera sensor information, YES determination is made in step S702, and in a case where the execution available duration prediction unit 13A has not detected an object from the camera sensor information, NO determination is made in step S702.

In the process of step S702, when the execution available duration prediction unit 13A has not detected an object from the camera sensor information (in the case of NO determination in step S702), the execution available duration prediction unit 13A returns to the process of step S701 and repeatedly executes the processes of steps S701 to S702.

On the other hand, in the process of step S702, when the execution available duration prediction unit 13A has detected an object from the camera sensor information (in the case of YES determination in step S702), the execution available duration prediction unit 13A predicts the start timing of the execution available duration M4 based on the information of the detected object (step S703). In this process, for example, the execution available duration prediction unit 13A predicts start timing of the execution available duration M4 by predicting the timing of temporary stop of the vehicle based on image information of the object such as “traffic light displaying yellow”, “railroad crossing”, “temporary stop line/temporary stop sign”, and “bus stopped at bus stop” illustrated in FIG. 17. After the process of step S703, the prediction process of the execution available duration by the execution available duration prediction unit 13A is ended.

Note that the verification target choosing unit 15 dynamically chooses a verification scenario that can be executed from the verification scenario M3 based on the start timing of the execution available duration M4 predicted by the execution available duration prediction unit 13A.

### Effects

As described above, in the vehicle control device 1A according to the present embodiment, the execution available duration prediction unit 13A detects an object from the camera sensor information and predicts the start timing of the execution available duration M4 based on the object information M8 which is image information of an arbitrary object indicating that the automatic driving ends. In addition, the verification target choosing unit 15 chooses a verification scenario that can be dynamically executed based on the predicted start timing of the execution available duration M4. Therefore, the vehicle control device 1A according to the present embodiment can obtain the same effects as those of the vehicle control device 1 according to the first embodiment.

### Third Embodiment

Next, a configuration example and an operation example of a vehicle control device according to a third embodiment of the present invention will be described.

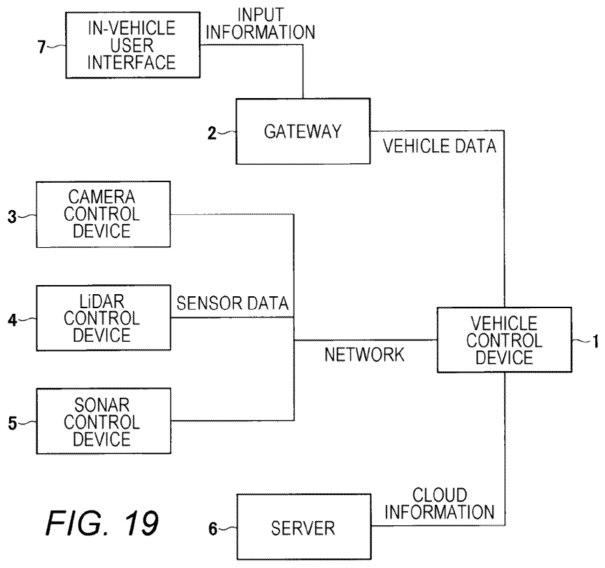

FIG. 19 is a diagram for describing a connection relationship in the vehicle by the vehicle control device according to the present embodiment. As can be seen by comparing FIG. 19 and FIG. 1, in the present embodiment, the vehicle control device 1 acquires information indicating that the automatic driving ends from the in-vehicle user interface 7 (e.g., an in-vehicle instrument panel) via the gateway 2. Note that the acquisition destinations of the various types of information of the vehicle control device 1 other than the in-vehicle user interface 7 are similar to the acquisition destinations of the various types of information (camera control device 3, LIDAR control device 4, sonar control device 5, and server 6) described in FIG. 1, and thus redundant description will be omitted.

In addition, in the vehicle control device 1 according to the present embodiment, each component other than the execution available duration prediction unit 13 is similar to each component illustrated in FIG. 2, and thus redundant description will be omitted. In the vehicle control device 1 according to the present embodiment, the execution available duration prediction unit 13 predicts the execution available duration M4 based on the information indicating that the automatic driving ends acquired from the in-vehicle user interface (in-vehicle user interface 7) illustrated in FIG. 19 instead of predicting the execution available duration M4 based on the “cloud information” (see FIG. 4) in the external environmental information M1.

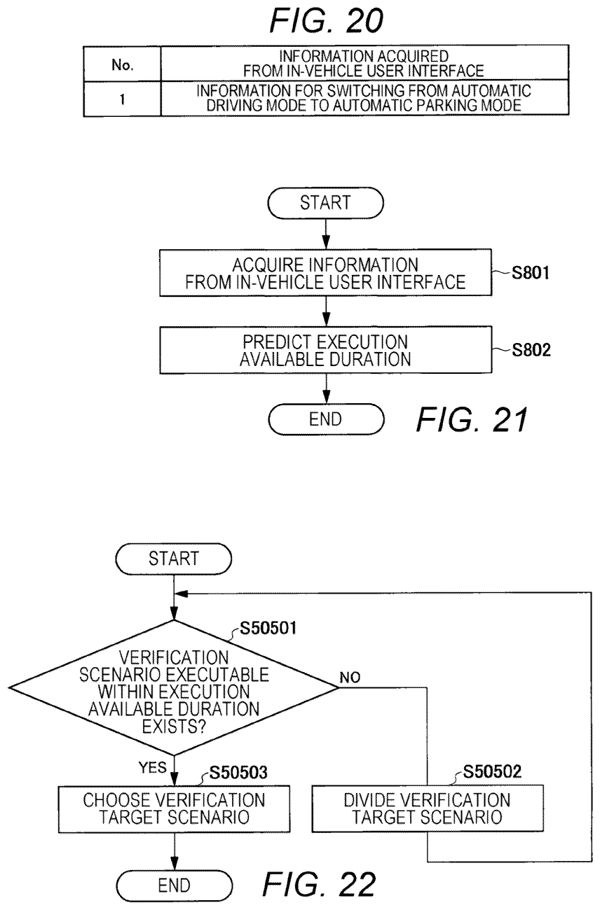

FIG. 20 is a diagram illustrating an example of data of information acquired from the in-vehicle user interface 7 in the vehicle control device 1 according to the present embodiment. The information acquired from the in-vehicle user interface 7 is information that is generated by the driver operating the in-vehicle user interface 7 and indicates that the automatic driving ends, and includes, for example, “information of switching from the automatic driving mode to the automatic parking mode” illustrated in FIG. 20. For example, when the driver presses a parking button displayed on the in-vehicle user interface 7, the vehicle is switched from the automatic driving mode to the automatic parking mode, and the vehicle is controlled to be automatically parked in the parking space.

FIG. 21 is a flowchart illustrating a procedure of a prediction process of the execution available duration in the execution available duration prediction unit 13 of the vehicle control device 1 according to the present embodiment. The process described below is started when the execution available duration prediction unit 13 acquires information from the in-vehicle user interface 7.

First, the execution available duration prediction unit 13 acquires information from the in-vehicle user interface 7 (step S801).

Next, the execution available duration prediction unit 13 predicts the execution available duration M4 based on the information acquired from the in-vehicle user interface 7 (step S802). In this process, the execution available duration prediction unit 13 predicts the execution available duration M4 of the current SW during the automatic parking based on, for example, information of switching from the automatic driving mode to the automatic parking mode acquired from the in-vehicle user interface 7 illustrated in FIG. 20. After the process of step S802, the prediction process of the execution available duration by the execution available duration prediction unit 13 is ended.

### Effects

As described above, in the vehicle control device 1 according to the third embodiment of the present invention, the execution available duration prediction unit 13 predicts the execution available duration M4 based on the information indicating that the automatic driving ends acquired from the in-vehicle user interface 7. In addition, the verification target choosing unit 15 chooses a verification scenario that can be dynamically executed according to the predicted execution available duration M4.

Therefore, the vehicle control device 1 according to the third embodiment of the present invention can obtain the same effects as those of the vehicle control device 1 according to the first embodiment.

Note that it is also assumed that the automatic driving mode is automatically switched to the automatic parking mode and the vehicle is parked in the parking space when the vehicle arrives near the destination without the driver performing an explicit operation of pressing the parking button. In this case, the execution available duration prediction unit 13 may predict the execution available duration M4 when detecting that the vehicle is switched from the automatic driving mode to the automatic parking mode.

### Fourth Embodiment

Next, an operation example of a vehicle control device according to a fourth embodiment of the present invention will be described.

In the vehicle control device 1 according to the present embodiment, when a verification scenario that can be executed and completed within the execution available duration M4 cannot be chosen in the verification scenario selecting process (step S505 in FIG. 11), the verification target choosing unit (verification target choosing unit 15) chooses by dividing the verification scenario M3 into sizes that can be executed and completed within the execution available duration M4. Note that redundant description of configurations and procedures of various processes similar to those of the first embodiment will be omitted.

FIG. 22 is a flowchart illustrating a procedure of dividing process of the verification target scenario in the verification target choosing unit 15 of the vehicle control device 1 according to the present embodiment. The process described below is executed by replacing step S505 of the verification scenario selecting process illustrated in FIG. 11.

After the process of step S504 of the verification scenario selecting process illustrated in FIG. 11, the verification target choosing unit 15 determines whether or not a verification scenario that can be executed and completed within the execution available duration M4 exists (step S50501).

In the process of step S50501, when the verification target choosing unit 15 determines that no verification scenario that can be executed and completed within the execution available duration M4 exists (in the case of NO determination in step S50501), the verification scenario M3 is divided into sizes that can be executed and completed within the execution available duration M4 (step S50502). After the process of step S50502, the verification target choosing unit 15 returns to the process of step S50501.

On the other hand, in the process of step S50501, when determining that a verification scenario that can be executed and completed within the execution available duration M4 exists (in the case of YES determination in step S50501), the verification target choosing unit 15 selects a verification scenario that can be executed and completed (step S50503). After the process of step S50503, the verification target choosing unit 15 executes the process of step S506 in FIG. 11.

Note that the computation unit 14 executes the divided verification scenarios with the new SW, integrates the execution results of each of the divided verification scenarios, and outputs the result as the execution result of the new SW.

### Effects

As described above, in the vehicle control device 1 according to the fourth embodiment of the present invention, when the verification scenario that can be executed and completed within the execution available duration M4 cannot be chosen, the verification target choosing unit 15 selects the verification scenario by dividing the verification scenario M3 into sizes that can be executed and completed within the execution available duration M4. Therefore, the vehicle control device 1 according to the fourth embodiment of the present invention has the same effect as the vehicle control device 1 according to the first embodiment, and can further improve the verification efficiency of the automatic driving control software.

### Fifth Embodiment

Next, an operation example of a vehicle control device according to a fifth embodiment of the present invention will be described.

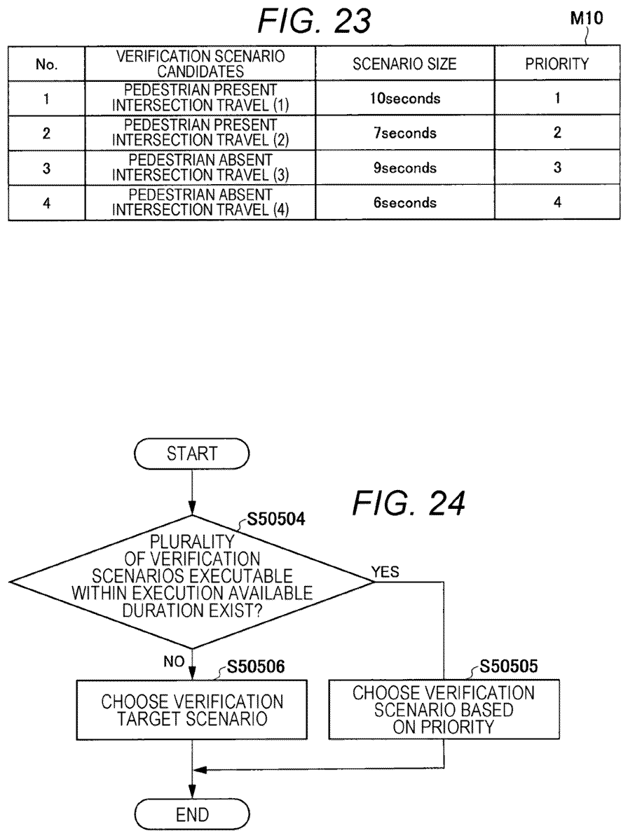

In the vehicle control device 1 according to the present embodiment, in the verification scenario selecting process (step S505 in FIG. 11), when a plurality of verification scenarios that can be executed and completed within the execution available duration M4 exist, the verification target choosing unit (verification target choosing unit 15) chooses the verification scenario based on the priority of the verification scenario set in advance (see FIG. 23 described later). Note that redundant description of configurations and procedures of various processes similar to those of the first embodiment will be omitted.

FIG. 23 is a diagram illustrating an example of data of a verification scenario to which priority is assigned in the vehicle control device 1 according to the present embodiment. As illustrated in FIG. 23, in a verification scenario M10, for example, “1” to “4” are assigned as “priority” to the verification scenarios “No. 1” to “No. 4”, respectively. In the present embodiment, “1” of “priority” illustrated in FIG. 23 is the highest priority, and “1” to “4” are the arrangement order from the highest priority to the lowest priority. Note that the method of setting the “priority” is not limited to this, and any setting method can be applied as long as the information data can distinguish the priority order of the verification scenario.

FIG. 24 is a flowchart illustrating a procedure of a verification scenario selecting process in the verification target choosing unit 15 of the vehicle control device 1 according to the present embodiment. The process described below is executed by replacing step S505 of the verification scenario selecting process illustrated in FIG. 11.

After the process of step S504 of the verification scenario selecting process illustrated in FIG. 11, the verification target choosing unit 15 determines whether or not a plurality of verification scenarios that can be executed and completed within the execution available duration M4 exist (step S50504).

In the process of step S50504, when a plurality of verification scenarios that can be executed and completed within the execution available duration M4 exist (in the case of YES determination in step S50504), the verification target choosing unit 15 chooses a verification scenario based on the priorities of the plurality of verification scenarios (step S50505). In this process, for example, the verification target choosing unit 15 chooses a verification scenario of “No. 2” with a high priority based on the priorities “2” and “4” of the verification scenarios of “No. 2” and “No. 4” illustrated in FIG. 23 that can be executed and completed within “8 seconds” (the execution available duration M4).

On the other hand, in the process of step S50504, when determining that a plurality of verification scenarios that can be executed and completed within the execution available duration M4 do not exist (in the case of YES determination in step S50504), the verification target choosing unit 15 selects a verification scenario that can be executed and completed (step S50506).

After the process of step S50505 or step S50506, the verification target choosing unit 15 executes the process of step S506 of FIG. 11.

### Effects

As described above, in the vehicle control device 1 according to the fifth embodiment of the present invention, when a plurality of verification scenarios that can be executed and completed within the execution available duration M4 exist, the verification target choosing unit 15 chooses a verification scenario based on the priorities of the plurality of verification scenarios. Therefore, the vehicle control device 1 according to the fifth embodiment of the present invention has the same effect as the vehicle control device 1 according to the first embodiment, and can further improve the verification efficiency of the automatic driving control software.

### Sixth Embodiment

Next, an operation example of a vehicle control device according to a sixth embodiment of the present invention will be described.

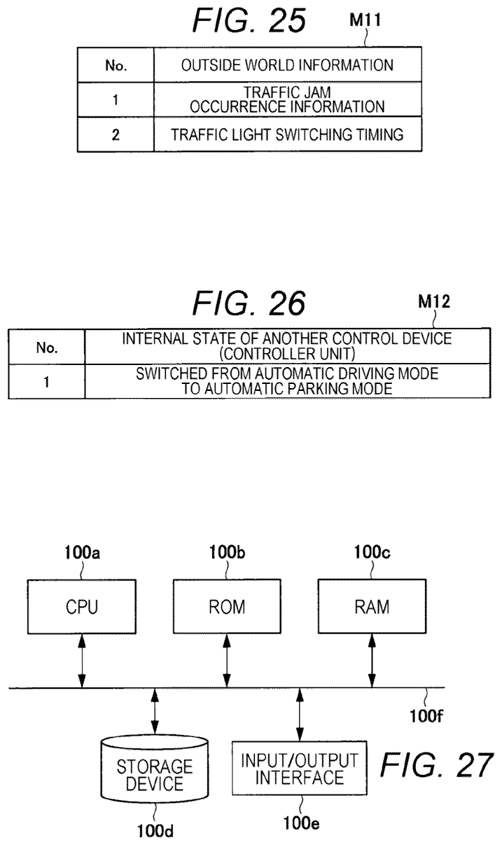

In the vehicle control device 1 according to the present embodiment, the execution available duration prediction unit 13 does not predict the execution available duration M4 based on the “cloud information” illustrated in FIG. 4, but predicts the execution available duration M4 based on arbitrary outside world information acquired via the cloud communication illustrated in FIG. 25. Note that redundant description of configurations and procedures of various processes similar to those of the first embodiment will be omitted.

FIG. 25 is a diagram illustrating an example of outside world information acquired by the vehicle control device 1 according to the present embodiment. The arbitrary outside world information acquired via the cloud communication includes, for example, information such as “traffic jam occurrence information” and “traffic light switching timing” illustrated in FIG. 25. The execution available duration prediction unit 13 predicts the execution available duration during the temporary stop of the vehicle due to traffic jam, for example, based on the “traffic jam occurrence information”. Furthermore, the execution available duration prediction unit 13 predicts the execution available duration during which the vehicle is stopped at the intersection based on, for example, the red light duration at the intersection ahead of the vehicle and the “traffic light switching timing”. Note that information such as “traffic jam occurrence information” and “traffic light switching timing” acquired via the cloud communication illustrated in FIG. 25 may be treated as the “cloud information” illustrated in FIG. 4.

### Effects

As described above, in the vehicle control device 1 according to the sixth embodiment of the present invention, the execution available duration prediction unit 13 predicts the execution available duration M4 based on arbitrary outside world information acquired via the cloud communication. Since the execution available duration prediction unit 13 predicts the execution available duration M4 based on various outside world information, the vehicle control device 1 according to the fourth embodiment of the present invention can obtain the same effect as the vehicle control device 1 according to the first embodiment and can accurately predict the execution available duration M4.

### Seventh Embodiment

Next, an operation example of a vehicle control device according to a seventh embodiment of the present invention will be described.

The vehicle control device 1 according to the present embodiment is configured to be able to transmit and receive various types of data to and from another control device (controller unit) (not illustrated) connected to the vehicle control device 1 (own device). Then, in the vehicle control device 1, the execution available duration prediction unit (the execution available duration prediction unit 13) does not predict the execution available duration M4 based on the “cloud information” (see FIG. 4) in the external environmental information M1, but predicts the execution available duration M4 based on the information on an internal state of another control device acquired via the gateway 2. Note that redundant description of configurations and procedures of various processes similar to those of the first embodiment will be omitted.

FIG. 26 is a diagram illustrating an example of information on an internal state of another control device acquired by the vehicle control device 1 according to the present embodiment. The information on the internal state of the another control device acquired via the gateway 2 includes, for example, information indicating a state “switched from the automatic driving mode to the automatic parking mode” illustrated in FIG. 26.

### Effects

As described above, in the vehicle control device 1 according to the seventh embodiment of the present invention, the execution available duration prediction unit 13 predicts the execution available duration M4 based on the information on the internal state of another control device. For example, in a case where the external environmental information M1 cannot be acquired due to a failure of a sensor, a failure of cloud communication, or the like, the execution available duration prediction unit 13 can predict the execution available duration M4 based on information on an internal state of another control device, and thus the vehicle control device 1 according to the seventh embodiment of the present invention can obtain the same effect as the vehicle control device 1 according to the first embodiment, and verify a new SW even in a case where a failure of a sensor, a failure of cloud communication, or the like has occurred.

### Hardware Configuration Example of Vehicle Control Device

FIG. 27 is a block diagram illustrating a hardware configuration example of the vehicle control device according to each of the above-described embodiments. The function of the vehicle control device is realized by an information processing device such as a microcomputer. As illustrated in FIG. 27, the vehicle control device includes a central processing unit (CPU) 100a, a read only memory (ROM) 100b, a random-access memory (RAM) 100c, a storage device 100d, and an input/output interface 100e. A bus 100f is a signal path that electrically connects the components and inputs and outputs signals between the components.

The CPU 100a controls the operation of each unit in the vehicle control device. For example, the CPU 100a controls the acquisition process of the external environmental information in the information acquisition unit 11, the saving process of the verification scenario in the verification scenario saving unit 12, and the like. In addition, the CPU 100a controls the prediction process of the execution available duration in the execution available duration prediction unit 13, the process in the computation unit 14, the choosing process of the verification scenario in the verification scenario choosing unit 15, the verification process of the new automatic driving control software in the verification unit 16, and the like.

The ROM 100b includes, for example, a storage medium such as a nonvolatile memory, and stores programs, data, and the like executed and referred to by the CPU 100a.

The RAM 100c includes, for example, a storage medium such as a volatile memory, and temporarily stores information (data) necessary for each process performed by the CPU 100a.

The storage device 100d is configured by a non-transitory computer-readable recording medium storing a program to be executed by the CPU 100a, and is configured by a storage device such as a hard disk drive (HDD). The storage device 100d stores a program for the CPU 100a to control each unit, a program for an operating system (OS) and a controller, and data. Note that a part of the program and data stored in the storage device 100d may be stored in the ROM 100b. Furthermore, the storage device 100d is not limited to the HDD, and may be, for example, a recording medium such as a solid state drive (SSD), a compact disc (CD)-ROM, or a digital versatile disc (DVD)-ROM.

The input/output interface 100e transmits and receives signals to and from the outside under the control of the CPU 100a.

Note that the present invention is not limited to the above-described embodiments, and it goes without saying that various other application examples and modified examples can be taken without departing from the gist of the present invention described in the claims.

For example, each of the above-described embodiments describes the configuration of the vehicle control device in detail and specifically in order to describe the present invention in an easy-to-understand manner, and is not necessarily limited to one including all the described configurations. In addition, a part of the configuration of the embodiment described herein can be replaced with the configuration of another embodiment, and furthermore, the configuration of another embodiment can be added to the configuration of an embodiment. Furthermore, for a part of the configuration of each embodiment, other configurations can be added, deleted, and replaced.

In addition, control lines and information lines that are considered necessary for the description are illustrated, and not all control lines and information lines are necessarily illustrated in terms of product. In practice, it may be considered that almost all the configurations are connected to each other.

### Reference Signs List

1, 1A vehicle control device
11 information acquisition unit
12 verification scenario saving unit
13, 13A execution available duration prediction unit
14 computation unit
15 verification target choosing unit
16 verification unit

1. A vehicle control device comprising:
an execution available duration prediction unit configured to predict an execution available duration of a current automatic driving control software program based on external environmental information of a vehicle;
a verification target choosing unit configured to choose, from verification scenarios for verifying performance of a new automatic driving control software program, a verification scenario executable and completable within the execution available duration as a verification target; and
a computation unit configured to execute the verification target with a new automatic driving control software program in the execution available duration.

2. The vehicle control device according to claim 1, further comprising a verification unit configured to verify a new automatic driving control software program based on a computation result of the current automatic driving control software program in which the computation is executed by the computation unit at a time other than the execution available duration and a computation result of a new automatic driving control software program in which the computation is executed by the computation unit within the execution available duration.

3. The vehicle control device according to claim 2, wherein the external environmental information includes sensor information acquired from a sensor that detects an external environment of the vehicle.

4. The vehicle control device according to claim 3, wherein the sensor information includes a video of an intersection ahead of the vehicle and a video of a traffic light ahead of the vehicle.

5. The vehicle control device according to claim 3, wherein the external environmental information includes cloud information acquired by cloud communication.

6. The vehicle control device according to claim 5, wherein the cloud information includes red duration of a forward traffic light, traffic jam occurrence information, and a traffic signal switching timing.

7. The vehicle control device according to claim 3, wherein the external environmental information includes image information of an object indicating that automatic driving ends.

8. The vehicle control device according to claim 7, wherein the image information of the object includes image information of a traffic light displaying yellow, image information of a railroad crossing, image information of a temporary stop line, image information of a temporary stop sign, and image information of a bus stopped at a bus stop.

9. The vehicle control device according to claim 2, wherein the execution available duration prediction unit predicts the execution available duration based on information indicating that the automatic driving ends acquired from an in-vehicle user interface of the vehicle.

10. The vehicle control device according to claim 9, wherein the information indicating that the automatic driving ends acquired from the in-vehicle user interface of the vehicle includes information for the vehicle to switch from an automatic driving mode to an automatic parking mode.

11. The vehicle control device according to claim 2, wherein
when the verification scenario executable and completable within the execution available duration does not exist,
the verification target choosing unit chooses the verification target by dividing the verification scenario into sizes executable and completable within the execution available duration.

12. The vehicle control device according to claim 2, wherein
when a plurality of the verification scenarios executable and completable within the execution available duration exist,
the verification target choosing unit chooses the verification target based on a priority of the verification scenario set in advance.

13. The vehicle control device according to claim 2, wherein the execution available duration prediction unit predicts the execution available duration based on information on an internal state of another control device of the vehicle.

14. The vehicle control device according to claim 13, wherein the information on the internal state of the another control device includes information indicating a state in which the vehicle is switched from the automatic driving mode to the automatic parking mode.
